(19) United States
(12) Patent Application Publication
(10) Pub. No.: US 2017/0359460 A1
(43) Pub. Date: Dec. 14, 2017

(54) Text Prevention Device

(71) Applicants: Jonathan Wayne Jackson, Houston, TX (US); Oliver Eugene Stubblefield, Houston, TX (US)

(72) Inventors: Jonathan Wayne Jackson, Houston, TX (US); Oliver Eugene Stubblefield, Houston, TX (US)

(21) Appl. No.: 15/235,925

(22) Filed: Aug. 12, 2016

Related U.S. Application Data
(60) Provisional application No. 62/392,904, filed on Jun. 14, 2016.

(51) Int. Cl. H04M 1/725; H04B 1/3877; B60R 16/02; B60R 11/02

(52) U.S. Cl. CPC H04M 1/72577; H04M 1/72527; B60R 11/0241; H04B 1/3877; B60R 16/0207

(57) ABSTRACT

A text-prevention device designed to restrict the cell-phone user from texting while driving a vehicle. This device, which is installed in the vehicle, into which the phone is inserted, is a clear, rectangular-shaped case with designated openings for the user to answer the phone and access specific numbers. The device has an electrical plug at the base which fits into the cell phone's port and serves to provide power to the phone. It also serves as an electrical component to help start the vehicle and maintain operability once the phone has been inserted into the device.

This invention is a text prevention device designed to prohibit a cell phone user from texting and driving. Once installed into the vehicle, the device helps to manage and reduce the distraction that texting causes during driving. The housing of this device is composed of a translucent or clear material which allows the driver to see the features of the phone but prohibits them from using the normal texting features. The designed thickness of the housing material composition eliminates the touch-activation feature normally present on the screen of a cell phone. With specially designated openings in the housing of the device, the driver may still access some features to maintain the usability of the cell phone. The device uses its wire harness and the cell phone in conjunction to complete the circuitry of the vehicle starting system as well as to continuously operate the vehicle. This invention will create a new habit of safety first for the drivers with regard to simultaneous cell phone usage.

### BACKGROUND OF THE INVENTION

In today's ever-changing society, there is the desire of many people to stay on the cutting edge of technology and social issues. People feel as though they must remain connected at all times. Our 24-hour world means that things never stop; people almost never sleep or pause. There was an era when driving was a time of peace, thoughtfulness and or even conversation between the driver and the passenger. Talking on the phone and texting have taken the place of that. Along with this, distracted driving and subsequently an increase in lives lost has created a need for this invention.

The concept of this invention is simple. It is designed to prohibit texting and driving. Once this device has been installed into the vehicle, the driver must insert their cell phone into the device to activate the vehicle starting system. In order that the driver may still have use of their phone—except its normal texting feature—while in transport, specifically designated access points to the cell phone face have been included in this invention. This invention is also equipped with a feature designed to maintain the functionality of the vehicle while the phone is properly connected to the device but then diminishes operational functionality of the vehicle if the phone is removed from the device while the vehicle is in operation.

Research for this present invention uncovered only three other text prevention ideas. U.S. Pat. No. 8,855,682 and U.S. Pat. No. 9,179,297, both by Robert Osann, Jr., which are systems for safe texting while driving, prescribes the use of a third party signal to prohibit the use of the texting after a certain velocity is determined. U.S. Pat. No. 8,594,705, also by Osann, Jr., as well employs the use of a signal to disable the texting feature of the phone through the service provider while the vehicle is being driven. All of these inventions have their specific features. However, they are vastly dissimilar to this present invention in design, description, application and approach to the text prevention concept.

This invention and its concept will slowly create a habit that revives the idea of safety first when operating a vehicle and simultaneously saving lives of potential victims and drivers while remaining connected via the technological advancements known as cell phones.

### SUMMARY OF THE INVENTION

The present invention is a text-prevention device designed to prohibit texting and driving by the cell phone user. It is a rectangular-shaped case with an opened end into which the cell-phone is inserted. The device has a clear front panel that prohibits the touch-activation of the phone but has designated openings to access the cell phone's specific features which allows it to still be answered while prohibiting the common texting feature. The phone plug connects to the top of the wire harness which is connected to the vehicle starting system. The cell phone connects to the phone plug within the device at the opposite end from the opening of the device. Upon this insertion and connection to the text-prevention device, the vehicle starting system is activated and the vehicle becomes operational.

### BRIEF DESCRIPTION OF THE DRAWINGS

The present invention and complete understanding thereof will become apparent as the description is given of the drawings.

FIG. 1A is a front view of the device.

FIG. 1B is a side view of the device.

FIG. 2A is the view from the top of the device.

FIG. 2B is a perspective and bottom side view of the device.

FIG. 3A is a front view of the device with a phone inserted inside and mounted on the connector and base.

FIG. 3B is the back view of FIG. 3A.

FIG. 4 is an exploded perspective view of the device showing the phone base and connection disconnected from the wire harness.

### DETAILED DESCRIPTION OF THE INVENTION

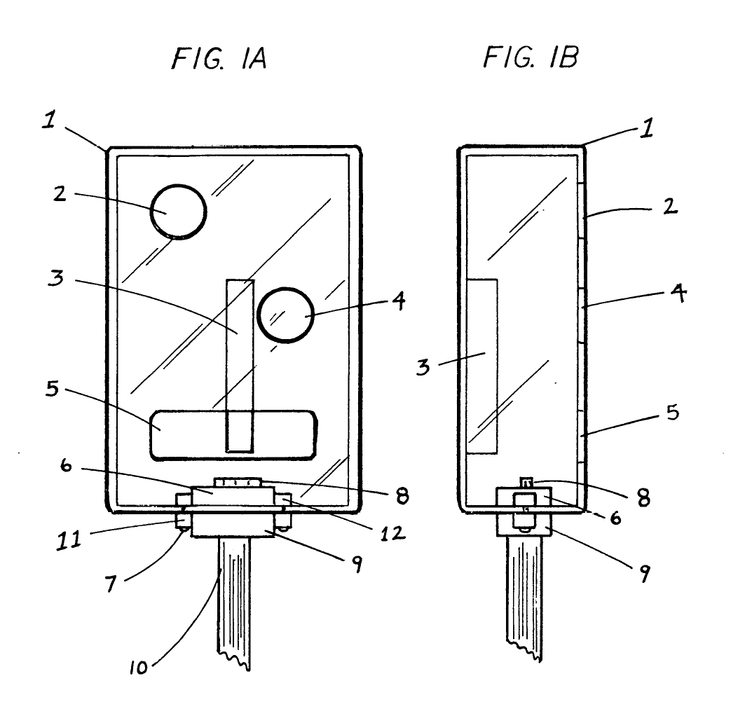

FIG. 1A shows the front view of the device. This view of the device, which is comprised of a clear material, shows the features numbered as 1 through 12. Feature 1 refers to the phone housing of the device. The phone housing is clear in its material composition and is rectangular in its shape. Features 2, 4 and 5 are designated openings in the front of the device. Features 2 and 4 are round while feature 5 is rectangular in shape. Feature 3 is the phone guide and is a solid rectangular-shaped feature that is connected to the center of the back of the interior wall of the device and protrudes into the interior of the device. It descends vertically towards the base of the device. Feature 6 is the phone base located inside of the device. It is also the top of the wire harness and also holds the phone connection, feature 8. Feature 9 is the top of the wire harness and the connection to feature 6 inside the housing of the device. Two parts of the base, 6 and 9, are connected by base fasteners labeled as feature 7 through the exterior and interior fastener housings or features 11 and 12 respectively. Feature 10 is the wire harness that provides power to the device.

FIG. 1B is a side view of the device. This view shows the same properties and components that are present in FIG. 1A.

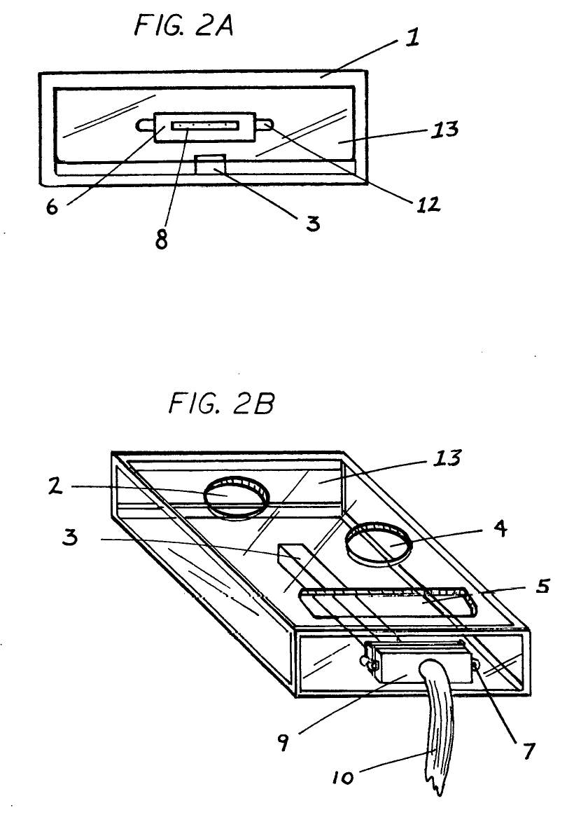

FIG. 2A is the top view of the device. Through feature 13, which is the open top of the device, other features such as 3, 6, 8, and 12 are the same as described in FIG. 1A. In this view, 13 can be shown as being more narrow than the width of the device. Feature 3 can be seen as centered on the back wall of the device housing and protruding towards feature 6, which is centered on the bottom surface of the device.

FIG. 2B is a perspective and bottom view of the device. Indicated in this view are some of the components of the device as described in FIG. 1A and feature 13 described in FIG. 2A.

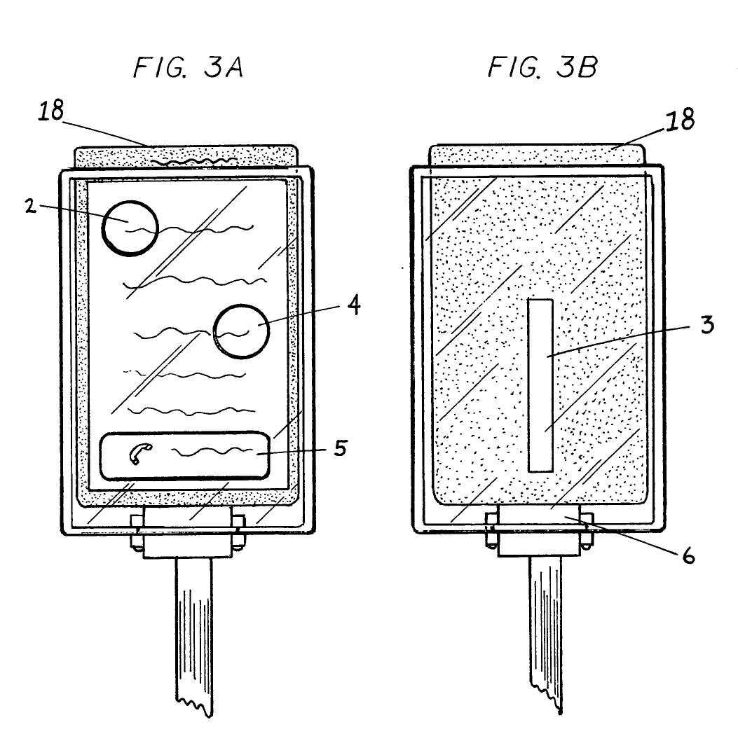

FIG. 3A is a front view of the device. This view is the same as FIG. 1A. Indicated in this view is the inclusion of a cell phone, 18, inserted into the housing of the device. Features 2, 4, and 5 are included to show access to the phone surface using these features.

FIG. 3B is the opposite view of FIG. 3A. It is the back view of the device with the cell phone, 18, inserted. The cell phone is also completely inserted and positioned on 6, the phone base. Feature 3, phone guide, is indicated here. Also visible are other features previously indicated in other views. The phone connection, previously indicated as feature 8 in FIG. 1A, is not visible in this view nor the opposite view, FIG. 3A, because it is inserted into the port of the cell phone which is completed mounted onto the phone base, feature 6.

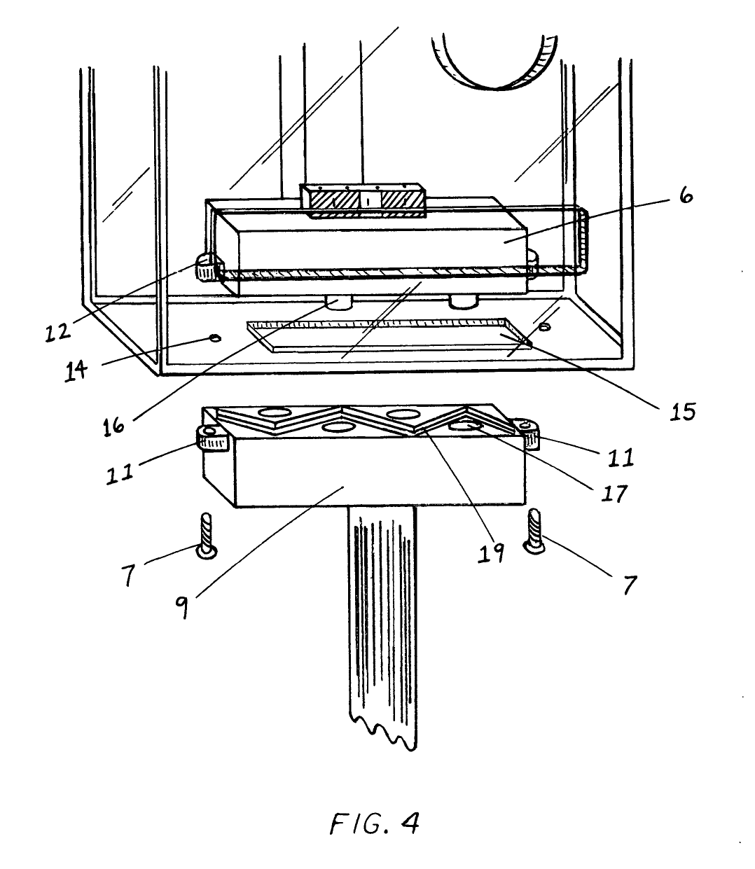

FIG. 4 is an exploded perspective view. In this view, the phone base, feature 6, located inside the device housing, is visible and disconnected from the top of the wire harness, feature 9, located on the exterior of the device. Shown also are previously indicated features such as 7, 11, and 12. Feature 14, the base fastener entry, indicates the connection point of features 11 and 12 by 7 through the device housing. Also visible is feature 16, the male harness connectors, and feature 17, female harness connectors. 16 and 17 are connected through feature 15, the harness connection port, located on the bottom of the device housing. Feature 19, the harness stability groove, secures the connectivity of features 16 and 17 of the phone base and wire harness.

This present invention is a new invention designed to provide a solution to the problem of texting and driving. This invention, once installed, works in conjunction with a vehicle to prevent the phone user from texting while operating the vehicle. There are modifications that may be made thereunto the present invention without departing from the spirit and scope of the invention.

What is claimed is:

1. A device for preventing simultaneous texting on a cell phone and driving by the cell phone user comprising:
a rectangular-shaped housing with an opening at one end;
a cell phone base and connection located on the interior bottom of the housing opposite the open end of the housing;
a wire harness that connects to the cell phone base through the bottom exterior wall of the housing.

2. A device according to claim 1 wherein the device may be composed of plastic, polyurethane, nylon, metal, leather or a combination of materials thereof.

3. A device according to claim 1 wherein the housing will be comprised of materials that are clear or translucent but which prohibit activation of the inserted phone when touched.

4. A device according to claim 1 wherein a wall of the housing has designated openings through which the phone screen may be accessed once a cell phone is inserted.

5. A device according to claim 1 wherein the device connects to a vehicle electrical system via the wire harness of the device.

6. A device according to claim 1 wherein a cell phone, once inserted into the device, serves to complete the electrical operating circuit for a vehicle.

7. A device according to claim 1 wherein once a phone is removed from the device will disengage the vehicle's electric operating circuitry resulting in the vehicle becoming inoperable.

8. A device according to claim 1 wherein the device components will be replaceable.
